(19) United States
(12) Patent Application Publication
(10) Pub. No.: US 2008/0178916 A1
(43) Pub. Date: Jul. 31, 2008

(54) Apparatus for Monitoring Operation of a Dishwasher Device and Associated System and Method

(75) Inventor: Fred Dennis Kedjierski, Kinston, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 11/627,176

(22) Filed: Jan. 25, 2007

(51) Int. Cl. A47L 15/42; G03B 21/00; G03B 21/22

(52) U.S. Cl. 134/57 D; 134/113; 353/62; 353/71

(57) ABSTRACT

An apparatus for monitoring operation of a dishwasher device is provided. Such an apparatus comprises a light projection device operably engaged with the dishwasher device and configured to project light therefrom. The projected light is configured to form at least one of an alphanumeric character and a graphical character, corresponding to a status of the dishwasher device. The projected light is adapted to be directed onto a surface adjacent to the dishwasher device such that the status is readable by a user. Associated systems and methods are also provided.

### BACKGROUND OF THE INVENTION

1. Field of the Invention

Embodiments of the present invention are directed to dishwasher devices and, more particularly, to an apparatus for monitoring the operation of a dishwasher device and associated system and method.

2. Description of Related Art

Some dishwasher devices may be configured for a “clean look” front panel (access panel). Such a front panel may be, for example, hinged about a lower end of an access opening of the dishwashing compartment (i.e., a front-loading dishwasher device), or associated with a forward-facing portion of a drawer (i.e., a drawer-type dishwasher device). Regardless of the configuration of the front panel, some dishwashers may be configured for a “clean look” from a frontal perspective. For example, stainless steel dishwashers may be configured such that the front panel appears as a continuous uninterrupted sheet of stainless steel. In other instances, the dishwasher may, for example, have a front panel with a facade consistent with the appearance of the adjacent cabinetry attached to the front panel such that, when closed, the front panel appears to be part of the cabinetry.

In such instances, the control panel and associated display(s) for the dishwasher may be mounted, for example, on the upper edge of the front panel. Accordingly, the front panel must be opened, for example, to set or change the controls for the dishwashing process, or to determine the operational status of the dishwasher (i.e., to set a “normal” dishwashing cycle or to determine the amount of time left in an ongoing cycle). If a dishwashing cycle is ongoing, opening the front panel may cause the cycle to be interrupted, and may undesirably release dishwashing fluid, food soils, heat, and/or steam from the dishwashing compartment. In some such instances, such as when the dishwasher is operating in an ongoing cycle, a colored (i.e., red or blue) light may be projected from the dishwasher. However, such a configuration merely indicates whether or not the dishwasher is actively engaged in a dishwashing cycle (i.e., as an “on/off” indicator).

As such, there exists a need for an apparatus, system, and method for monitoring operation of a dishwasher device without requiring the front panel to be opened, for example, to set or change the controls for the dishwashing process, or to determine the operational status of the dishwasher, via the control panel/status display that is typically concealed about an upper edge of the front panel. There exists a further need for a need for an apparatus, system, and method for monitoring operation of a dishwasher device during operation that provides status information while reducing or eliminating the risk of interrupting a dishwashing cycle and/or undesirably releasing dishwashing fluid, food soils, heat, and/or steam from the dishwashing compartment by opening the front panel of the dishwasher device. Such a solution should also provide the user with usable information about the status of the dishwasher device, rather than just functioning as an “on/off” indicator.

### BRIEF SUMMARY OF THE INVENTION

The above and other needs are met by embodiments of the present invention which, according to one aspect, provides an apparatus for monitoring operation of a dishwasher device, comprising a light projection device operably engaged with the dishwasher device and configured to project light therefrom. The projected light is configured to form at least one of an alphanumeric character and a graphical character, corresponding to a status of the dishwasher device. The projected light is thus adapted to be directed onto a surface adjacent to the dishwasher device so as to be readable by a user.

Another aspect of the present invention provides a dishwashing system, comprising a dishwasher device for washing dishware, and a light projection device operably engaged with the dishwasher device and configured to project light therefrom. The projected light is configured to form at least one of an alphanumeric character and a graphical character, corresponding to a status of the dishwasher device. The projected light is thus adapted to be directed onto a surface adjacent to the dishwasher device so as to be readable by a user.

Yet another aspect of the present invention provides a method of monitoring operation of a dishwasher device. Light is projected from a light projection device operably engaged with the dishwasher device, wherein the projected light is configured to form at least one of an alphanumeric character and a graphical character, corresponding to a status of the dishwasher device. The light is further projected onto a surface adjacent to the dishwasher device such that the status is readable by a user.

Aspects of the present invention thus address the above needs and provide significant advantages as otherwise detailed herein

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1 and 2 are schematics of alternate dishwasher devices according to various embodiments of the present invention;

FIG. 3 is a schematic of a dishwasher device including an apparatus for monitoring operation thereof, according to one embodiment of the present invention; and

FIG. 4 is a schematic of an apparatus for monitoring operation of a dishwasher device according to one embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

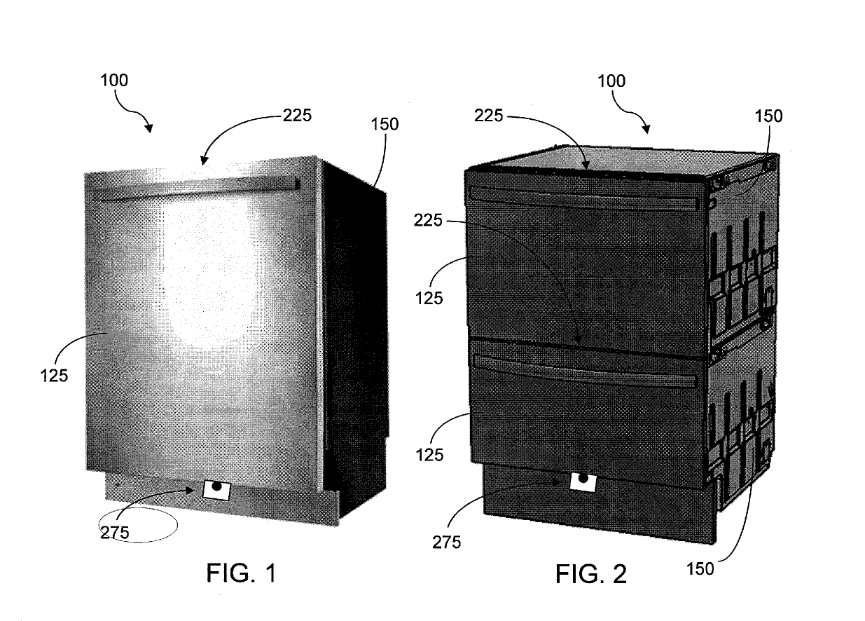

FIG. 1 illustrates a dishwasher device according to one aspect of the present invention, the dishwasher device being generally indicated by the numeral 100. Such a dishwasher device 100 is generally mounted in an under-counter installation, for example, in a kitchen or bar area. In the under-counter-installation, the dishwasher device 100 includes an access panel 125 capable of being opened to provide access to the dishwashing compartment 150 therein. In this manner, dishware can be loaded into the dishwashing compartment 150 and then sealed by the access panel 125 such that the dishware can undergo a selected wash cycle. Such an access panel 125 may be, for example, hinged about a lower end of an access opening of the dishwashing compartment 150 (i.e., a front-loading dishwasher device as shown in FIG. 1), associated with a forward-facing portion of a drawer (i.e., a drawer-type dishwasher device as shown in FIG. 2), or provided as other variants or combinations thereof. Regardless of the configuration of the access panel 125, some dishwasher devices 100 may be configured for a “clean look” from a frontal perspective. For example, stainless steel dishwasher devices 100 may be configured such that the front access panel 125 appears as a continuous uninterrupted sheet of stainless steel. In other instances, the dishwasher device 100 may, for example, have a facade consistent with the appearance of the adjacent cabinetry attached to the front access panel 125 such that, when closed, the access panel 125 appears to be part of the cabinetry.

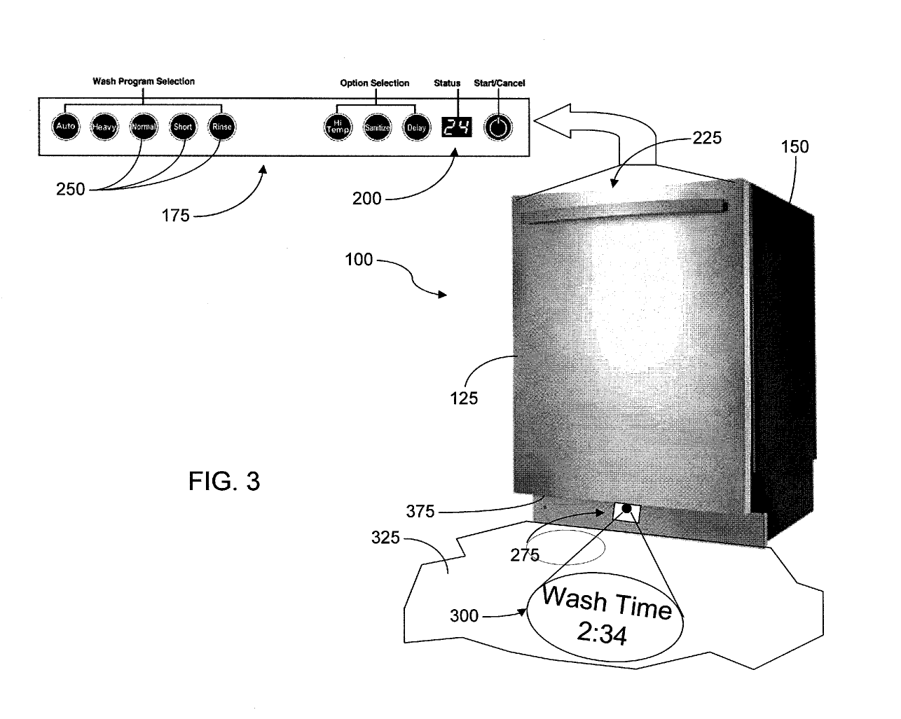

Even a “clean look” dishwasher device 100, however, requires a control panel 175 and, in some instances, an associated display 200, for setting and monitoring the various cycles of the dishwashing process, as shown in FIG. 3. As such the control panel 175/display 200 for a “clean look” dishwasher device 100 may be mounted, for example, on the upper edge 225 of the front access (door) panel 125 in order to preserve the “clean look” of the dishwasher device 100. Such a control panel 175 may include, for example, one or more control elements 250 which may comprise, for example, switches, buttons, dials, or other selector devices, for determining operational parameters of the dishwasher device 100. The display 200, when implemented, may include an LCD screen, an array of LED's, or any other suitable indicia capable of indicating an operational status of the dishwasher device 100 to a user. As previously discussed, though, a dishwasher device 100 thus configured often requires the access panel 125 to be at least partially opened with respect to the dishwashing compartment 150 in order to set and/or monitor the various cycles undergone by the dishwasher device 100 during the dishwashing process. In practice, the desired dishwashing process cycles are often set via the control panel 175 prior to the dishwashing process, and are often not changed during the dishwashing process itself. However, the user may often desire or need information with respect to the actual cycle or operational status of the dishwasher device 100, but opening of the access panel 125 to view this information may not be possible (i.e., the particular cycle may not allow the access panel 125 to be opened due to, for example, possible water leakage. escape of food soils, or release of heat/steam).

As such, one aspect of the present invention provides an apparatus 275 for monitoring the operation of a dishwasher device 100, where such a monitoring apparatus 275 is operably engaged with the dishwasher device 100, as shown in FIG. 3. The monitoring apparatus 275 may be provided in addition to the display 200, or instead of the display 200. In one embodiment, the monitoring apparatus 275 is configured to form an indicia 300 associated with the dishwasher device 100 on a surface 325 adjacent to or in proximity to the dishwasher device 100. In one embodiment, the surface 325 may comprise, for example, the floor opposite the access panel 125 from the dishwashing compartment 150. That is, the surface 325 may be the floor in front of the dishwasher device 100.

One skilled in the art will appreciate, however, that the designation of a floor herein is but one example of a suitable surface 325, wherein such a surface 325 may comprise one or more of many different surfaces about the dishwasher device 100 such as, for example, a ceiling, a wall, a countertop, and/or a cabinet adjacent to the dishwasher device 100. Accordingly, the use of a floor surface herein is for exemplary purposes only, and the monitoring apparatus 275 may have different configurations depending on the nature of the surface 325 and the disposition and/or proximity thereof with respect to the dishwasher device 100. In still further instances, the monitoring apparatus 275 may be configured such that the user may select the surface 325 upon which the indicia 300 is to be formed or projected. In such instances, the user may, for example, physically change an orientation and/or direction of all or part of the monitoring apparatus 275, or a plurality of monitoring apparatuses 275 may be provided from which the user is able to select one or more thereof according to preference.

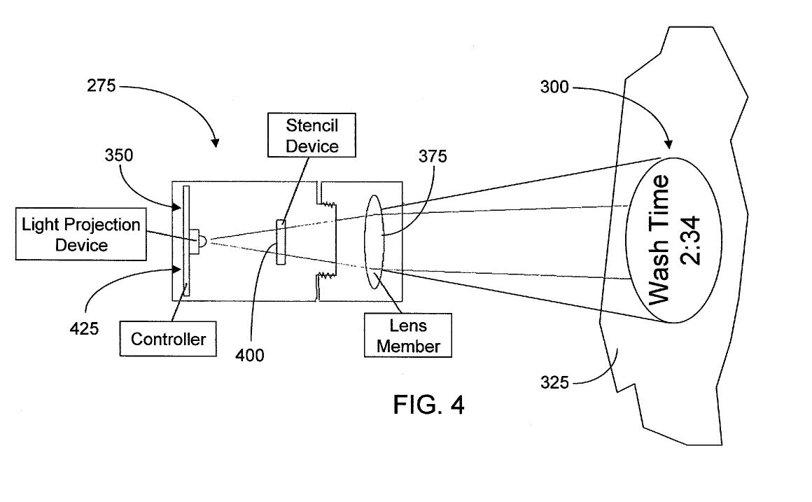

The indicia 300 formed by the monitoring apparatus 275 may be configured, for example, to indicate the status of the dishwasher device 100, for instance, in alphanumeric and/or graphical (icon) characters. In one embodiment, the indicia 300 is formed by light emitted from the monitoring apparatus 275 and projected onto the surface 325 (i.e., the floor in front of the dishwasher device 100). In such instances, as shown in FIGS. 3 and 4, the monitoring device 275 may comprise, for example, a light projection device 350 operably engaged with the dishwasher device 100, for example, about the lower edge 375 of the access panel 125. The light projection device 350 may comprise a light source such as, for example, one or more light-emitting diodes (LED's), though the light source may comprise any suitable device, such as an incandescent bulb. The light emitted by the light projection device 350 is focused on the surface 325, for instance, by a lens member 375 or other suitable device, wherein the lens member 375 may have a focusing device (not shown) operably engaged therewith, if necessary. In some instances, however, the light emitted by the light projection device 350 may be sufficiently focused that a lens member 375 may not be required. In still other instances, various focusing and/or directional optical components such as, prisms, reflective surfaces, or other appropriate elements, may be implemented to obtain an indicia 300 on the surface 325, as disclosed herein.

The alphanumeric and/or graphical characters of the indicia 300 may include, for example, a letter associated with a cycle of the dishwasher device, a word associated with a cycle of the dishwasher device, a number associated with a cycle of a dishwasher device, a time associated with a cycle of the dishwasher device, a graphical indicia associated with the dishwasher device, and combinations thereof. More particularly, the indicia 300 may be configured to monitor operation of the dishwasher device 100 by providing, for instance, a numeric indication of the amount of time elapsed (or amount of time remaining) in a particular cycle, words associated with the cycle or the numeric indication (i.e., “Time Remaining,” “Time Elapsed,” “Normal Wash,” “Heated Dry”), and/or an icon, such as the manufacturer's logo or an icon representing a “Heated Dry” cycle. Such a configuration of the indicia 300 thus provides usable alphanumeric and/or graphical status information to the user (as compared, for example, to merely an “on/off” indicator), without the user having to open the access panel 125 to determine such information from the control panel 175/display 200.

Because the indicia 300 is projected onto the surface 325 in front of the dishwasher device 100, in one example, one aspect of the present invention involves projecting the indicia 300 such that the indicia 300 is readable by or otherwise legible to the user standing in front of the dishwasher device 100. As such, the monitoring apparatus 275 may further comprise a stencil device 400 for forming a negative image of the status to be displayed by the indicia 300. Such a stencil device 400 may comprise, for example, a liquid crystal display (LCD) or other suitable device configured form the negative image of the status and to transmit light at least partially therethrough. The negative image of the status is also appropriately reversed (i.e., laterally along the string of alphanumeric and/or graphical characters, or upside down with respect to the string) such that the light directed therethrough by the light projecting device 350 (and focused by the lens member 375, if necessary) forms the indicia 300, as projected onto the surface 325, to be readable by and legible (i.e., in “non-reversed” and/or “non-inverted” form) to the user facing the dishwasher device 100. That is, the user looking at the floor, for example, in front of the dishwasher device 100 should be able to clearly read and comprehend the status of the dishwasher device 100 via the indicia 300 projected onto the floor. The same criteria apply to any other surface 325 upon which the indicia 300 may be projected.

In one embodiment, the monitoring apparatus 275 may also include a controller 425, such as a microprocessor, in communication with any or all of the control panel 175, the display 200, the light projection device 350, the lens member 375/focusing device, and the stencil device 400. Such a controller 425 may be configured to, for example, determine the status of the dishwasher device 100 including, for instance, the cycle, time left in the cycle, the following cycle, and the like. The status may be at least partially indicated by the control panel 175 and/or the display 200. Once the status is determined, the controller 425 sends an appropriate signal, corresponding to the determined status, to the stencil device 400 so as to form a negative and/or reversed image, as necessary, of the status on the stencil device 400. The controller 425 also directs the light projection device 350 to direct light through the stencil device 400 and, if necessary, also directs the lens member 375/focusing device to appropriately direct and/or focus the light from the stencil device 400 onto the surface 325. As a result, the alphanumeric and/or graphical characters corresponding to the status of the dishwasher device 100 are directed toward and onto the surface 325 adjacent to the dishwasher device 100 to provide the indicia 300 of the status to the user.

Many modifications and other embodiments of the inventions set forth herein will come to mind to one skilled in the art to which these inventions pertain having the benefit of the teachings presented in the foregoing descriptions and the associated drawings. For example, one skilled in the art will appreciate that the light projection device 350 may be configured to emit a variety or combination of colors of light, or that the monitoring apparatus 275 may be otherwise configured to project various colors, or combinations of colors, of light. Further, the monitoring apparatus 275 may be configured for various functionality such as, for example, to selectively display the status of the dishwasher device 100 (i.e., when such an option is selected on the control panel 175 prior to actuating the dishwasher device 100 to begin the dishwashing process), to continuously display the status of the dishwasher device 100 upon latching or closing the access panel 125 of the dishwasher device 100, or to display the status of the dishwasher device 100 during intervals when the dishwasher device 100 is actively engaged in a particular cycle. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus for monitoring operation of a dishwasher device, comprising:
a light projection device operably engaged with the dishwasher device and configured to project light therefrom, the projected light being configured to form at least one of an alphanumeric character and a graphical character, corresponding to a status of the dishwasher device, the projected light being adapted to be directed onto a surface adjacent to the dishwasher device so as to be readable by a user.

2. An apparatus according to claim 1 wherein the projected light is further configured as a reverse image of the status, such that the projected light directed onto the surface is readable in non-reversed form by the user.

3. An apparatus according to claim 1 further comprising a controller device operably engaged with the light projection device, the controller device being configured to determine the status of the dishwasher device and to configure the light projection device to project light corresponding to the status.

4. An apparatus according to claim 1 wherein the light projection device further comprises a light source for projecting light therefrom toward the surface.

5. An apparatus according to claim 4 wherein the light source further comprises a light-emitting diode.

6. An apparatus according to claim 4 wherein the light projection device further comprises a stencil device disposed between the light source and the surface, the stencil device being configured to generate the status of the dishwasher device as a reverse negative image such that the light projected from the light source is directed therethrough toward the surface and such that the status is readable on the surface, in non-reversed positive form, by the user.

7. An apparatus according to claim 6 wherein the stencil device further comprises a liquid crystal display.

8. An apparatus according to claim 4 wherein the light projection device further comprises a lens member disposed between the light source and the surface for focusing the projected light, corresponding to the status, on the surface.

9. An apparatus according to claim 1 wherein the status is further selected from the group consisting of a letter associated with a cycle of the dishwasher device, a word associated with a cycle of the dishwasher device, a number associated with a cycle of a dishwasher device, a time associated with a cycle of the dishwasher device, a graphical indicia associated with the dishwasher device, and combinations thereof.

10. A dishwashing system, comprising:
a dishwasher device for washing dishware; and
a light projection device operably engaged with the dishwasher device and configured to project light therefrom, the projected light being configured to form at least one of an alphanumeric character and a graphical character, corresponding to a status of the dishwasher device, the projected light being adapted to be directed onto a surface adjacent to the dishwasher device so as to be readable by a user.

11. A system according to claim 10 wherein the projected light is further configured as a reverse image of the status, such that the projected light directed onto the surface is readable in non-reversed form by the user.

12. A system according to claim 10 further comprising a controller device operably engaged with the status indicia apparatus, the controller device being configured to determine the status of the dishwasher device and to configure the light projection device to project light corresponding to the status.

13. A system according to claim 10 wherein the light projection device further comprises a light source for projecting light therefrom toward the surface.

14. A system according to claim 13 wherein the light source further comprises a light-emitting diode.

15. A system according to claim 13 wherein the light projection device further comprises a stencil device disposed between the light source and the surface, the stencil device being configured to generate the status of the dishwasher device as a reverse negative image such that the light projected from the light source is directed therethrough toward the surface and such that the status is readable on the surface, in non-reversed positive form, by the user.

16. A system according to claim 15 wherein the stencil device further comprises a liquid crystal display.

17. A system according to claim 13 wherein the light projection device further comprises a lens member disposed between the light source and the surface for focusing the projected light, corresponding to the status, on the surface.

18. A system according to claim 10 wherein the status is further selected from the group consisting of a letter associated with a cycle of the dishwasher device, a word associated with a cycle of the dishwasher device, a number associated with a cycle of a dishwasher device, a time associated with a cycle of the dishwasher device, a graphical indicia associated with the dishwasher device, and combinations thereof.

19. A method of monitoring operation of a dishwasher device, comprising:
projecting light from a light projection device operably engaged with the dishwasher device, the projected light being configured to form at least one of an alphanumeric character and a graphical character, corresponding to a status of the dishwasher device, onto a surface adjacent to the dishwasher device such that the status is readable by a user.

20. A method according to claim 19 wherein projecting light further comprises projecting light as a reverse image of the status, such that the light projected onto the surface is readable in non-reversed form by the user.

21. A method according to claim 19 further comprising determining the status of the dishwasher device, and directing the light projection device to project light corresponding to the status, with a controller device operably engaged with the dishwasher device and the light projection device.

22. A method according to claim 19 wherein projecting light further comprises projecting light from a light source toward the surface.

23. A method according to claim 22 wherein projecting light from a light source further comprises projecting light from a light-emitting diode toward the surface.

24. A method according to claim 22 wherein projecting light further comprises projecting light from the light source through a stencil device disposed between the light source and the surface.

25. A method according to claim 24 further comprising generating the status of the dishwasher device on the stencil device, as a reverse negative image, such that the light projected therethrough from the light source toward the surface forms a non-reversed positive image on the surface readable by the user.

26. A method according to claim 24 wherein projecting light from the light source through a stencil device further comprises projecting light from the light source through a stencil device comprising a liquid crystal display.

27. A method according to claim 22 wherein projecting light from a light source toward the surface further comprises projecting light from a light source toward the surface, through a lens member disposed therebetween, for focusing the projected light, corresponding to the status, on the surface.

28. A method according to claim 19 wherein projecting light corresponding to a status of the dishwasher device further comprises projecting light corresponding to a status selected from the group consisting of a letter associated with a cycle of the dishwasher device, a word associated with a cycle of the dishwasher device, a number associated with a cycle of a dishwasher device, a time associated with a cycle of the dishwasher device, a graphical indicia associated with the dishwasher device, and combinations thereof.
